(19) United States
(12) Patent Application Publication
(10) Pub. No.: US 2006/0076847 A1
(43) Pub. Date: Apr. 13, 2006

(54) Outer rotor type motor

(75) Inventor: Man Seung Han, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/245,372

(22) Filed: Oct. 7, 2005

(30) Foreign Application Priority Data
Oct. 8, 2004 (KR) 10-2004-0080253
Oct. 18, 2004 (KR) 10-2004-0080257

(51) Int. Cl. H02K 5/00

(52) U.S. Cl. 310/91

(57) ABSTRACT

An outer rotor type motor includes a rotation shaft installed in a bearing housing; a stator formed of a field winding; a rotor disposed outside the stator to house the stator and having a yoke surface on which a permanent magnet for performing a magnetic interaction with the field winding of the stator, the rotor rotating around the stator; and a shaft bushing for connecting the rotor and the rotation shaft. The shaft bushing is insert-molded at a central portion of the rotor to be connected with the rotor.

### FIELD OF THE INVENTION

The present invention relates to a shaft connecting mechanism for an outer rotor type motor having a rotor which rotates on an outer peripheral surface of a stator; and, more particularly, to a shaft connecting mechanism for enabling a stable and simple connection between a shaft of the outer rotor type motor and the rotor, thus simplifying the manufacture of the rotor while preventing a loss of a rotary power thereof.

### BACKGROUND OF THE INVENTION

With regard to various driving methods for a motor, there is a motor type driven by an induced electromotive force (hereinafter, this motor type will be referred to as an electric induction motor). Such an electric induction motor is a kind of AC motor in which a rotary power is generated by an interaction between a rotating magnetic field generated in a stator and an inductive magnetic field generated in the rotor. Also, this electric induction motor is of a rotating magnetic field type.

The electric induction motor can be designed in various ways, i.e., it can be designed as a three-phase induction motor, a three-phase winding type induction motor and so forth as well as a single-phase induction motor. It is one of AC motors easy to use, so it has been widely employed in various household electric appliances.

Given that it has a constant rotational speed depending on a load imposed thereon and a long lifetime, the electric induction motor is adequate as a power supply motor. As a small-sized motor, in particular, a single-phase type capacitor motor has been most widely utilized.

The electric induction motor basically includes a housing; a stator fixed in the housing; and a rotator connected with a rotation shaft rotatably supported in the housing via a bearing. The stator generates an induced magnetism by receiving a power from outside via a winding coil, and the rotor rotates along with the rotation shaft due to the induced magnetism generated by the stator.

In the electric induction motor with the above-described configuration, an electric current is induced to a secondary winding by an electromagnetic induction of a primary winding which is connected to a power supply, and a rotary power is obtained by an interaction between the current induced at the secondary winding and a rotating magnetic field. Such an electric induction motor can be classified into an inner rotor type or an outer rotor type depending on relative locations of the stator and the rotor.

Recently, an outer rotor type induction motor having a rotor installed outside a stator has wide applications, because it is capable of increasing a torque at a same volume, and, by using the outer rotor type motor, it is possible to use the inner space of the stator for another purpose.

In the outer rotor type induction motor, a rotor having a driving shaft, a magnet, a rotor case, and so forth rotates outside a stator which is formed of an iron core, a core, a base, a bearing, and so forth. That is, the rotor rotates around the stator.

The rotor of the outer rotor type induction motor is illustrated in FIG. 1.

In the figure, a rotor 1 is made of a steel material and forms a casing of the motor by being press-molded. The rotor 1 includes a rotor core 2 and a rotor bushing 3. The rotor core 2 has a laminated iron core 2a which is press-fitted to the inner peripheral surface of the rotor 1 after being fabricated by blanking; and a ring-shaped ending member 2b installed at an upper and a lower end of the laminated core 2a. The rotor bushing 3 is for connecting the rotor 1 with a rotation shaft (not shown).

As mentioned, the rotor 1 employs the rotor bushing 3 to deliver its rotary power to the rotation shaft. The coupling of the rotor 1 and the rotor bushing 3 is illustrated in FIG. 2.

As shown in FIG. 2, the rotation shaft 4 is inserted into the rotor bushing 3 and is fixed to the rotator bushing 3 via a bolt 6. When the rotation shaft 4 and the rotor bushing 3 are connected to each other, the rotor bushing 3 is fastened to the rotor 1 via a fixing protrusion 7 or a bolt 8.

However, with regard to the above-described configuration of the rotor 1, the whole assembly process has been difficult because the rotor core 2 having the laminated iron core 2a and the ending members 2b need to be press-fitted to the rotor 1. Furthermore, since the rotor bushing 3 and the rotor 1 are connected via the additional volt 6, a fastening force therebetween may not be strong enough, resulting in a reduction in stability of the rotor 1.

### SUMMARY OF THE INVENTION

It is, therefore, an object of the present invention to provide an outer rotor type motor including a shaft connecting mechanism, which allows a shaft bushing for connecting a rotor and a shaft to be fastened to the rotor simply and stably, thereby easing the assembly of the rotor while preventing a loss of a rotary power.

In accordance with a preferred embodiment of the present invention, there is provided an outer rotor type motor including: a rotation shaft installed in a bearing housing; a stator formed of a field winding; a rotor disposed outside the stator to house the stator and having a yoke surface on which a permanent magnet for performing a magnetic interaction with the field winding of the stator, the rotor rotating around the stator; and a shaft bushing for connecting the rotor and the rotation shaft, wherein the shaft bushing is insert-molded at a central portion of the rotor to be connected with the rotor.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view of a conventional rotor;

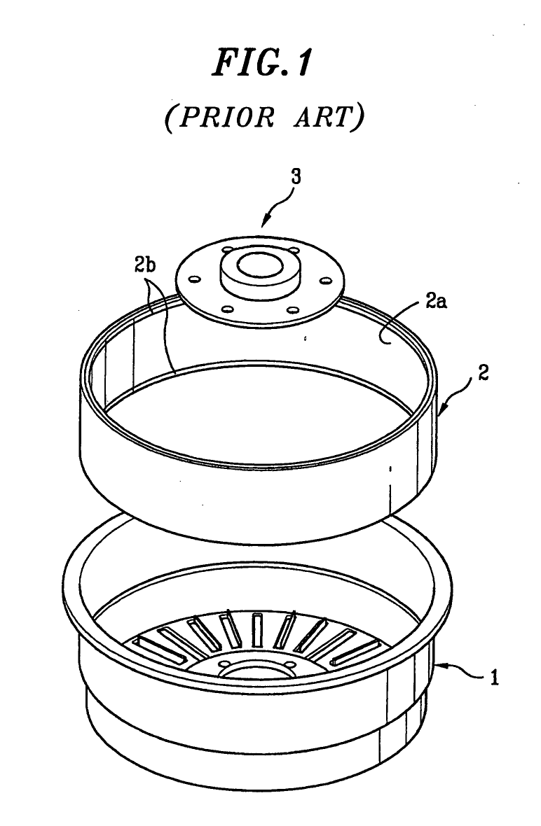

FIG. 2 illustrates the conventional rotor connected with a rotation shaft;

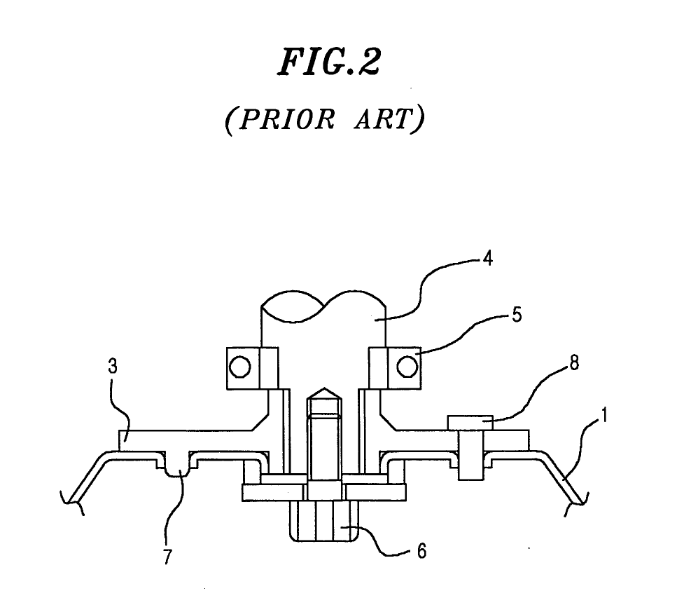

FIG. 3 provides a perspective view of a rotor in accordance with a first preferred embodiment of the present invention;

FIG. 4 sets forth a cross sectional view of a drum type washing machine employing the rotor in accordance with the first embodiment of the present invention;

FIG. 5 offers a cross sectional view to describe major components of FIG. 4;

FIG. 6 presents a perspective view of a rotor in accordance with a second preferred embodiment of the present invention; and

FIG. 7 depicts a cross sectional view to describe major components of FIG. 6.

### DETAILED DESCRIPTION OF THE PREFERRED EMBODIMENTS

The technical essence of the present invention lies in that a shaft bushing, which is used to-connect a shaft and a rotor for outputting a rotary power of a motor, is coupled to the rotor by press-fitting and insert-injection, whereby the assembly process can be simplified and a fastening force between the rotor and the shaft bushing can be enhanced, while preventing a loss of the rotary power.

Hereinafter, preferred embodiments of the present invention will be described in detail with reference to the accompanying drawings.

### First Preferred Embodiment

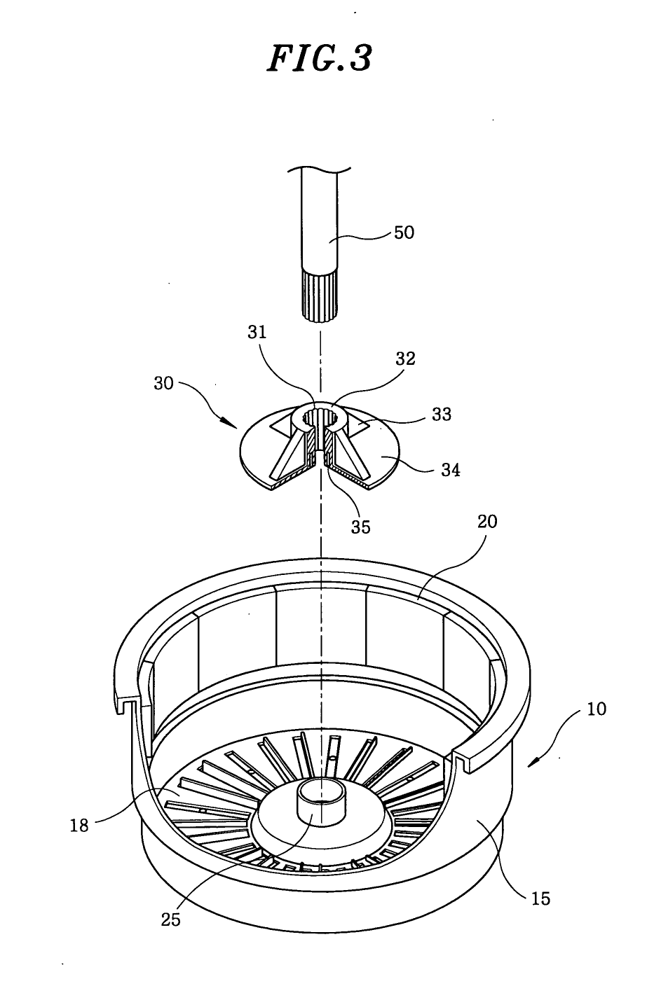

Referring to FIG. 3, a rotation shaft 50 which is supported in a bearing housing (not shown) is installed at a central portion of a rotor 10. The rotation shaft 50 is fastened to a shaft bushing 30 which is connected with the rotor 10. A serration 31 is formed at a central portion of the shaft bushing 30 to enhance the engagement of the rotation shaft 50 with the shaft bushing 30 when the rotation shaft 50 rotates. The presence of the serration 31 prevents a loss of a rotary power.

Further, the rotor 10 rotates outside a stator (not shown in FIG. 3) formed of a field winding, while accommodating the stator therein. Also, the rotor 10 has a yoke surface 15, wherein a permanent magnet 20 for performing a magnetic interaction with the field winding of the stator is installed on the yoke surface 15.

The shaft bushing 30 is coupled to the rotor 10 by being insert-molded while it is press-fitted to a central portion of the rotor 10. The connection between the rotor 10 and the shaft bushing 30 becomes complete and simple by a pressing force of the shaft bushing 30 and a molded coupling force by the insert-molding.

For the coupling of the shaft bushing 30 and the rotor 10, the shaft bushing 30 is configured to include an engagement hole 33 provided with the serration 31 on its inner surface to be engaged with the rotation shaft 50; reinforcing ribs 33 radially extended from the outer peripheral surface of the engagement hole 32; an insert portion 34 to be insert-molded with the rotor 10 while forming bottom surfaces of the reinforcing ribs 33; and an engagement groove 35 vertically formed in the sidewall of the engagement hole 32 starting from the lower surface of the insert portion 34.

Moreover, in a central portion of the rotor 10, an engagement boss 25 to be press-fitted into the engagement groove 35 is protrudingly formed at a position corresponding to the engagement groove 35. The rotor 10 is insert-molded while the engagement boss 25 is press-fitted into the engagement groove 35.

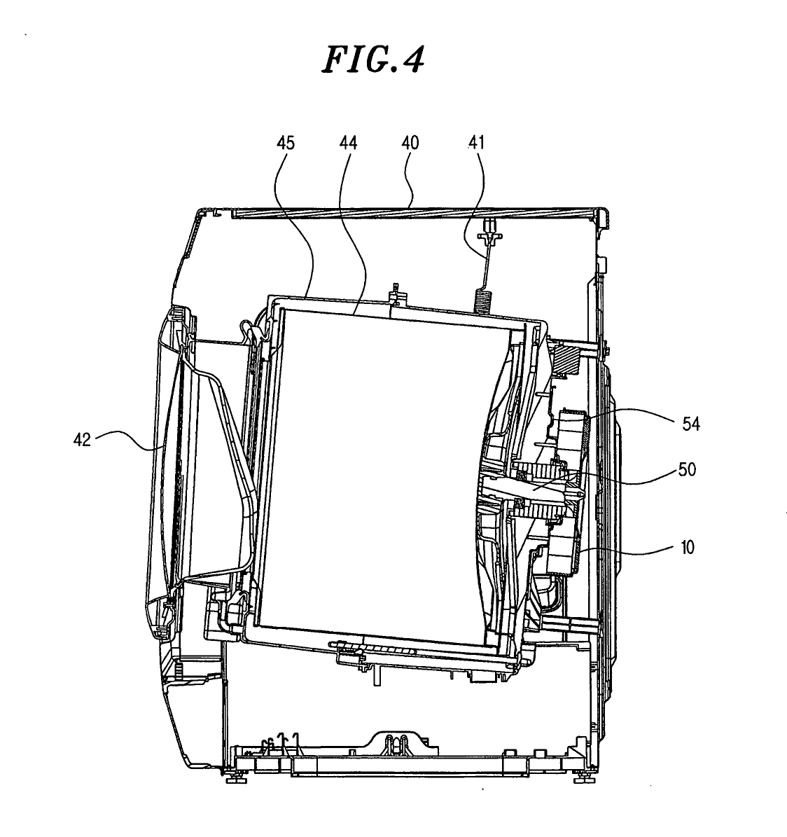

FIG. 4 shows a drum type washing machine employing the rotor 10 with the shaft bushing 30 connected thereto.

Here, it is to be noted that the present invention is not limited to the drum type washing machine illustrated in FIG. 4. FIG. 4 just shows an example of a motor unit to which the motor in accordance with the present invention is applicable. For example, though the below description will be provided for the drum type washing machine having a drum slantingly disposed, the rotor of the present invention can also be applied to a drum type washing machine having a drum horizontally installed. Various other modifications of the preferred embodiments are also possible.

The motor unit of the drum type washing machine is installed in a rear portion of a housing 40 which forms a casing of the washing machine. A door 42 is installed at a front portion of the housing 40, and by opening the door 42, laundry can be loaded into a drum 44 and a tub 45 suspended in the housing 40 via a suspension spring 41.

The drum 44 is rotatably installed inside the tub 45 and is connected to the motor. Specifically, the rear end portion of the drum 44 is injection-molded as one body with the shaft 50 of the motor so that the rotary power of the motor is delivered to the drum 44.

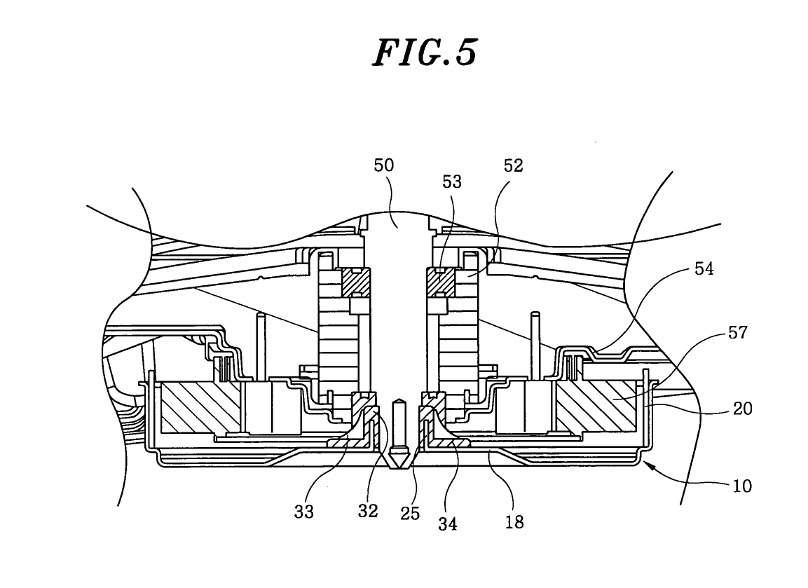

Meanwhile, as shown in FIG. 5, both ends of the shaft 50 connected to the drum 44 are supported by a bearing 53 installed at an inner side of a bearing house 52, and a base plate 54 of the motor is installed at one end side of the bearing housing 52 so that said one end side of the bearing housing 52 is isolated from the motor.

The base plate 54 is disposed to surround the bearing housing 52 and the rear portion of the tub 45. The base plate 54 serves to fix the bearing housing 52 of the motor to the tub 45 while protecting the rear outer surface of the tub 45. The base plate 54 also functions to separate the motor installed at one side thereof from the tub 45.

A stator 57 of the motor is fixed to the base plate 54 by a predetermined fixing mechanism, and the stator 57 performs a magnetic action with a preset field winding.

Moreover, the rotor 10 installed to house the stator 57 is of a cylindrical shape. The rotor 10 is disposed to surround the stator 57, and it has the permanent magnet 20 at the inner sidewall thereof, wherein the permanent magnet 20 performs a magnetic interaction with the stator 57.

The rotor 10 has a base portion 18 forming a bottom surface; and the yoke surface 15 vertically extended from the base portion 18, while forming the outer surface of the rotor 10. Installed at the center of the base portion 18 of the rotor 10 is the engagement boss 25. The insert portion 34 of the shaft bushing 30 and the base portion 18 of the rotor 10 are molded by insert-injection as one body while the engagement boss 25 is press-fitted into the engagement groove 35 of the shaft bushing 30.

Further, installed at the outer peripheral portion of the engagement hole 32 are the reinforcing ribs 33 which prevent a torsion of the shaft bushing 30 due to the rotary power of the engagement hole 32.

Since the shaft bushing 30 is fabricated as one body with the rotor 10, the shaft bushing 30 serves to connect the shaft 50 with the rotor 10, whereby the rotary power of the rotor 10 can be transferred to the shaft 50.

In case the washing machine is operated by the motor of the present invention configured as described above, a magnetic interaction between the stator 57 and the permanent magnet 20 attached on the yoke surface 15 of the rotor 10 makes the rotor 10 rotate with a preset rotary power, and the rotary power of the rotor 10 is delivered to the shaft bushing 30 which is adjoined to the rotor 10 as one body.

By the rotary power delivered to the shaft bushing 30, the shaft 50 supported in the bearing housing 52 via the bearing 53 is made to rotate, which in turn allows the drum 44 molded as one body with the shaft 50 to rotate as well. As a result, a washing process of the laundry in the drum 44 can be carried out.

In accordance with the first embodiment as described above, the base portion 18, the yoke surface 15 of the rotor 10 and the shaft bushing 30 are molded as one body by insert-injection, and the fabrication of the rotor 10 becomes easier through the use of the shaft bushing 30 which can be press-fitted to the rotor 10 and can be insert-molded therewith.

### Second Preferred Embodiment

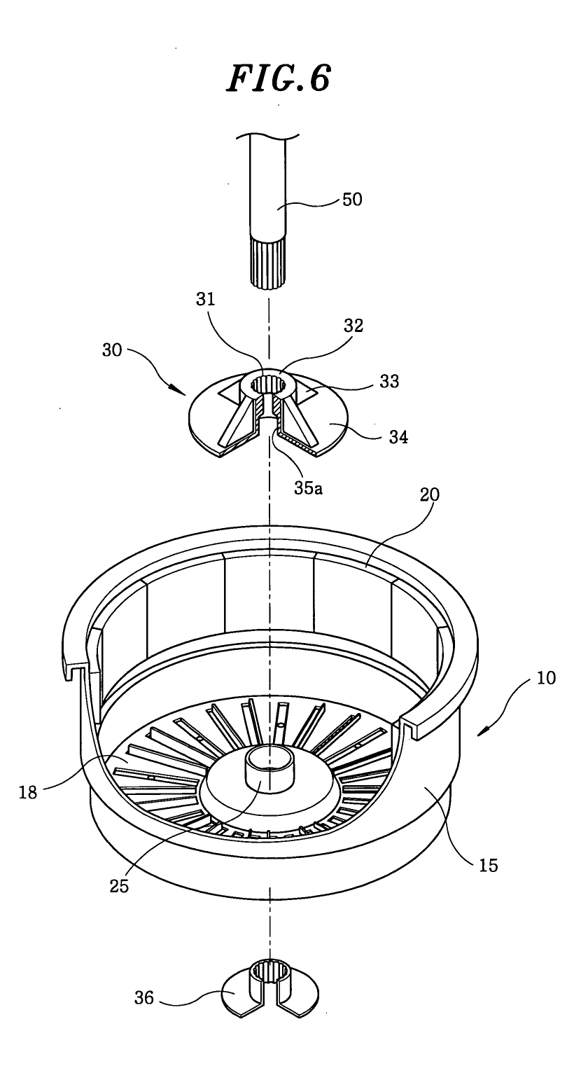

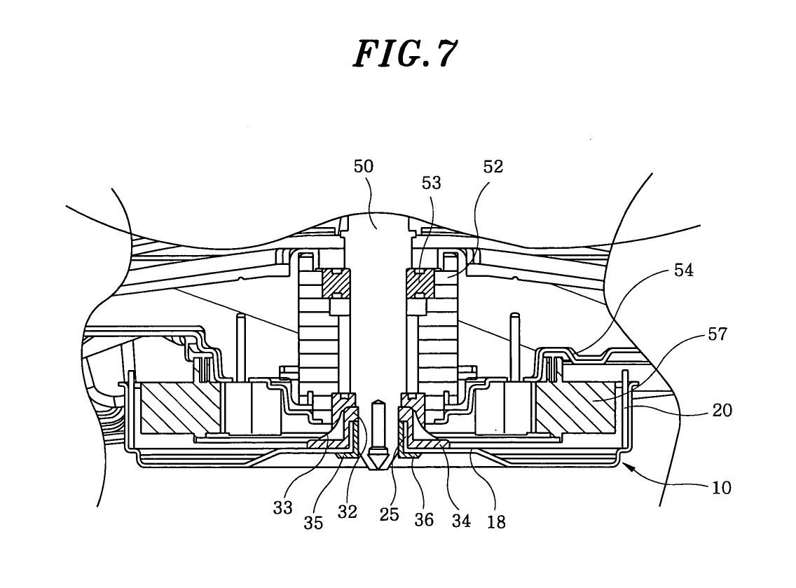

Below, an outer rotor type motor in accordance with a second preferred embodiment of the present invention will be described with reference to FIGS. 6 and 7. Parts identical to those described in the first embodiment will be assigned same reference numerals, and description thereof will be omitted.

Referring to FIGS. 6 and 7, a shaft bushing 30 is adjoined to the rotor 10 by being insert-molded at a central portion of the rotor 10, as described in the first embodiment. However, in accordance with the second embodiment, the insert-molding of the shaft bushing 30 is also progressed at a bottom side of a base portion 18 of the rotor 10 as well as at an upper side thereof, so that the rotor 10 and the shaft bushing 30 can be coupled to each other more completely.

For the coupling of the shaft bushing 30 and the rotor 10, the shaft bushing 30 includes a engagement hole 33 provided with a serration 31 on its inner surface to be engaged with a rotation shaft 50; reinforcing ribs 33 radially extended from the outer peripheral surface of the engagement hole 32; an insert portion 34 to be insert-molded with the rotor 10 while forming bottom surfaces of the reinforcing ribs 33; a stepped portion 35a formed by cutting a lower portion of the engagement hole 32 starting from the bottom surface of the insert portion 34; and an engagement portion 36 molded as one body with the insert portion 34 and the stepped portion 35a from beneath the rotor 10.

Further, in a central portion of the rotor 10, an engagement boss 25 to be fitted to the stepped portion 35a is protrudingly formed at a position corresponding to the stepped portion 35a. By insert-molding the engagement portion 36 from below the rotor 10 while the engagement boss 25 is fitted to the stepped portion 35a, the shaft bushing 30 is insert-molded at the upper and the bottom side of the rotor 10.

Moreover, the cylindrical rotor 10 has a base portion 18 forming a bottom surface; and a yoke surface 15 vertically extended from the base portion 18, while forming the outer surface of the rotor 10. Installed at the center of the base portion 18 of the rotor 10 is the engagement boss 25. The insert portion 34 of the shaft bushing 30 and the base portion 18 of the rotor 10 are molded by insert-injection as one body while the engagement boss 25 is press-fitted to the stepped portion 35a of the shaft bushing 30. At the same time, since the engagement portion 36 is insert-molded below the stepped portion 35a, the coupling force can be improved.

In accordance with the second embodiment as described above, the base portion 18 and the yoke surface 15 of the rotor 10 and the shaft bushing 30 are molded as one body with the rotor 10 by insert-injection. At this time, since the insert molding of the shaft bushing 30 is done at the upper and the bottom side of the base portion 18 of the rotor 10 at the same time, the coupling of the shaft bushing and the rotor can become more complete. Further, by using the connector mechanism as described above, the fabrication of the rotor 10 becomes easier.

By using the shaft connecting mechanism in accordance with present invention, the fabrication of an outer rotor type motor can be simplified, and a loss of a rotary power can be prevented. As a consequence, productivity and reliability of the motor can be improved.

While the invention has been shown and described with respect to the preferred embodiments, it will be understood by those skilled in the art that various changes and modification may be made without departing from the spirit and scope of the invention as defined in the following claims.

What is claimed is:

1. An outer rotor type motor comprising:
a rotation shaft installed in a bearing housing;
a stator formed of a field winding;
a rotor disposed outside the stator to house the stator, and having a yoke surface on which a permanent magnet for performing a magnetic interaction with the field winding of the stator, the rotor rotating around the stator; and
a shaft bushing for connecting the rotor and the rotation shaft,
wherein the shaft bushing is insert-molded at a central portion of the rotor to be connected with the rotor.

2. The motor of claim 1, wherein the shaft bushing includes:
an engagement hole provided with a serration to be engaged with the shaft;
reinforcing ribs radially extended from an outer peripheral surface of the engagement hole;
an insert portion to be insert-molded with the rotor while forming bottom surfaces of the reinforcing ribs; and
an engagement groove vertically formed in a sidewall of the engagement hole starting from a bottom surface of the insert portion.

3. The motor of claim 1, wherein the shaft bushing includes:
an engagement hole provided with a serration to be engaged with the shaft;
reinforcing ribs radially extended from an outer peripheral surface of the engagement hole;
an insert portion to be insert-molded with the rotor while forming bottom surfaces of the reinforcing ribs;
a stepped portion formed by cutting a lower portion of the engagement hole starting from a bottom surface of the insert portion; and
an engagement portion molded as one body with the insert portion and the stepped portion from beneath the rotor.

4. The motor of claim 2, wherein an engagement boss to be press-fitted into the engagement groove is protrudingly formed at a position corresponding to the engagement groove in a central portion of the rotor.

5. The motor of claim 3, wherein an engagement boss to be vertically fitted to the stepped portion is protrudingly formed at a position corresponding to the stepped portion in a central portion of the rotor.
